(19) United States
(12) Patent Application Publication
(10) Pub. No.: US 2008/0159096 A1
(43) Pub. Date: Jul. 3, 2008

(54) Information processing apparatus

(75) Inventor: Shigenobu Sato, Iruma-shi (JP)

Correspondence Address: BLAKELY SOKOLOFF TAYLOR & ZAFMAN, 1279 OAKMEAD PARKWAY, SUNNYVALE, CA, 94085-4040, US

(73) Assignee: Kabushiki Kaisha Toshiba

(21) Appl. No.: 11/827,784

(22) Filed: Jul. 13, 2007

(30) Foreign Application Priority Data
Dec. 27, 2006 (JP) P2006-352212

(51) Int. Cl. G11B 7/00; G11B 3/90; G11B 5/58

(52) U.S. Cl. 369/53.2; 369/100; 369/53.22; 720/718

(57) ABSTRACT

According to one embodiment, an information processing apparatus includes an optical disk drive that performs at least one of a read process and a write process for a plurality of kinds of optical disk, and a designation unit that designates at least one kind of an optical disk as a designated optical disk for which the at least one of the read process and the write process is performed, wherein the optical disk drive performs the at least one of the read process and the write process only for the designated optical disk.

### CROSS-REFERENCE TO RELATED APPLICATIONS

This application is based upon and claims the benefit of priority from Japanese. Patent Application No. 2006-352212, filed Dec. 27, 2006, the entire contents of which are incorporated herein by reference.

### BACKGROUND

1. Field

One embodiment of the invention relates to an information processing apparatus, for example, having a function of performing at least one of a read process and a write process for a plurality of kinds of optical disk.

2. Description of the Related Art

In recent years, an information processing apparatus such as a personal computer having an optical disk drive that can handle a plurality of kinds of optical disk such as CD-ROM, CD-RW and DVD-ROM has been developed. This information processing apparatus performs the read process or the write process for the optical disk, after identifying the kind of optical disk loaded into the optical disk drive.

A method for identifying the kind of optical disk is well known which includes making a discrimination operation preferentially from the optical disk of the kind having higher frequency of use by referring to use history information in the past and identifying the kind of optical disk loaded into the optical disk drive. It is disclosed by, for example, Japanese Patent Application Publication (KOKAI) No. H09-8434.

However, if the above identification method is applied to the information processing apparatus such as personal computer, it takes a long time to identify the kind of optical disk loaded into the optical disk drive, because the discrimination operation for another kind of optical disk must be performed while the discrimination operation for the optical disk is performed, when the optical disk having low frequency of use is loaded. As a result, there is a fear that it takes time to boot up the information processing apparatus.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view of a personal computer as an information processing apparatus according to an embodiment of the present invention;

FIG. 2 is an exemplary block diagram showing the system configuration of the personal computer as shown in FIG. 1 in the embodiment;

FIG. 3 is an exemplary block diagram showing the system configuration of an ODD as shown in FIG. 2 in the embodiment;

FIG. 4 is an exemplary flowchart showing a procedure for the read process or write process for the designated optical disk that is performed by the personal computer as shown in FIG. 2 in the embodiment; and

FIG. 5 is an exemplary view showing the kind of designated optical disk and its frequency of use in the embodiment.

### DETAILED DESCRIPTION

Various embodiments according to the invention will be described hereinafter with reference to the accompanying drawings. In general, according to one embodiment of the invention, an information processing apparatus includes an optical disk drive that performs at least one of a read process and a write process for a plurality of kinds of optical disk, and a designation unit that designates at least one kind of an optical disk as a designated optical disk for which the at least one of the read process and the write process is performed, wherein the optical disk drive performs the at least one of the read process and the write process only for the designated optical disk.

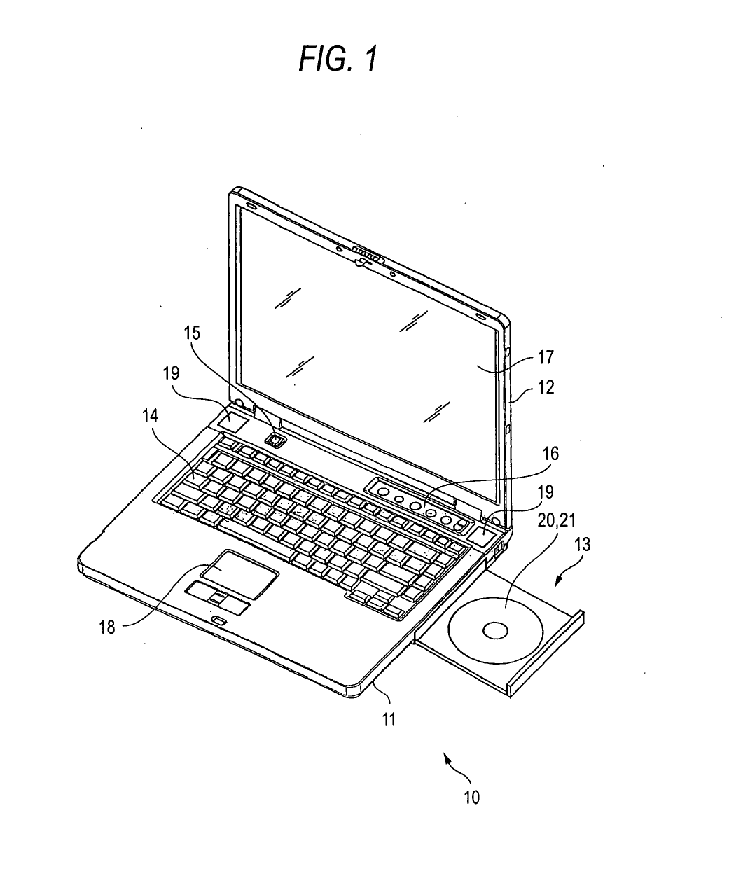

According to one embodiment, FIG. 1 shows a notebook type personal computer (information processing apparatus) 10 including a computer main body 11 and a display unit 12. The display unit 12 has built in a display device composed of an LCD (Liquid Crystal Display) 17, in which a display screen of the LCD 17 is disposed almost centrally in the display unit 12.

The display unit 12 is mounted on the computer main body 11 such that being rotatable between an open position and a closed position thereof. The computer main body 11 has a thin box-like housing, in which an optical disk drive (ODD) 13 is disposed on the right side face. Also, a keyboard 14, a power button 15 for turning ON/OFF the power of the personal computer 10, an input operation panel 16, a touch pad 18 and a speaker 19 are disposed on its upper surface.

The ODD 13 enables the read process or write process to be performed for a loaded optical disk 20. A plurality of kinds of optical disk 20 can be processed, including CD-ROM, CD-RW, CD+RW, DVD-ROM, and HD-DVD, for example. In this embodiment, at least one of the read process and the write process for only the designated optical disk 21 designated by the user from them can be performed.

The keyboard (designation unit) 14 is a part for designating the designated optical disk 21 by the user performing an input operation.

The display screen of the LCD (notify unit) 17 displays predetermined information for the user. For example, if the loaded optical disk 20 is different from the designated optical disk 21, a message to the effect that the loaded optical disk 20 is different from the designated optical disk 21 is displayed.

Next, the system configuration of the personal computer 10 will be described below.

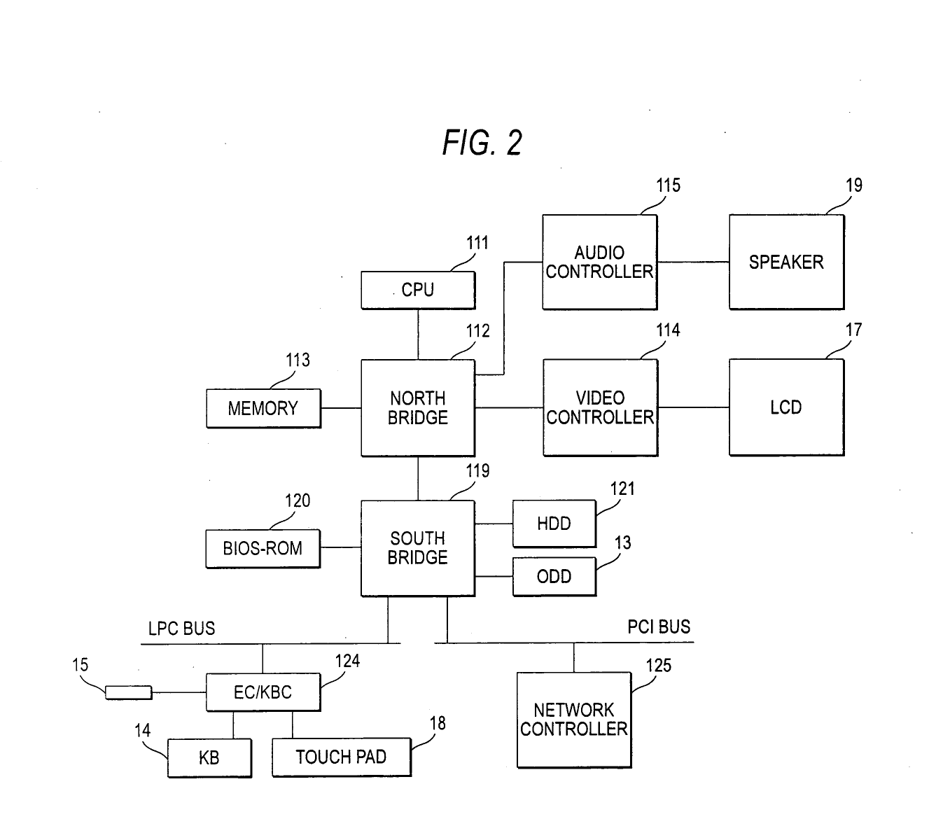

The personal computer 10 includes a CPU 111, a north bridge 112, a main memory 113, a video controller 114, an audio controller 115, a south bridge 119, a BIOS-ROM 120, a hard disk drive (HDD) 121, an embedded controller/keyboard controller IC (EC/KBC) 124 and a network controller 125, as shown in FIG. 2.

The CPU 111 is a processor provided to control the operation of the personal computer 10 by performing an operating system (OS) loaded from the HDD 121 into the main memory 113. Further, when the optical disk drive 13 enables at least one of the read process and the write process to be performed for the loaded optical disk 20, the CPU 111 executes these processes.

Also, the CPU 111 executes a system basic input output system (BIOS) stored in the BIOS-ROM 120. The system BIOS is a program for hardware control.

The north bridge 112 is a bridge device connecting a local bus of the CPU 111 and the south bridge 119. The north bridge 112 internally includes a memory controller for controlling access to the main memory 113. Also, the north bridge 112 has a function of making the communication with the video controller 114 and the audio controller 115 via an accelerated graphics port (AGP) bus.

The main memory 113 stores use history information indicating frequency of use of the designated optical disk 21.

The video controller 114 is a video reproduction controller for controlling the LCD 17 for use as a display monitor of the personal computer 10.

The audio controller 115 is an audio reproduction controller for controlling the speaker 19 of the personal computer 10.

The south bridge 119 controls each device on a low pin count (LPC) bus and each device on a peripheral component interconnect (PCI) bus. Also, the south bridge 119 internally includes an HDD 121 that is a storage device for storing various kinds of software and data and an integrated drive electronics (IDE) controller for controlling the ODD 13. Further, the south bridge 119 has a function of controlling access to the BIOS-ROM 120.

The EC/KBC 124 is one-chip microcomputer in which the embedded controller for power management and the keyboard controller for controlling the keyboard (KB) 13 and the touch pad 18 are integrated. This EC/KBC 124 has a function of turning ON/OFF the power of the personal computer 10 in accordance with a user's operation on the power button 15. The network controller 125 is a communication apparatus for performing the communication with an external network such as internet.

Next, the detailed system configuration of the ODD 13 will be described below.

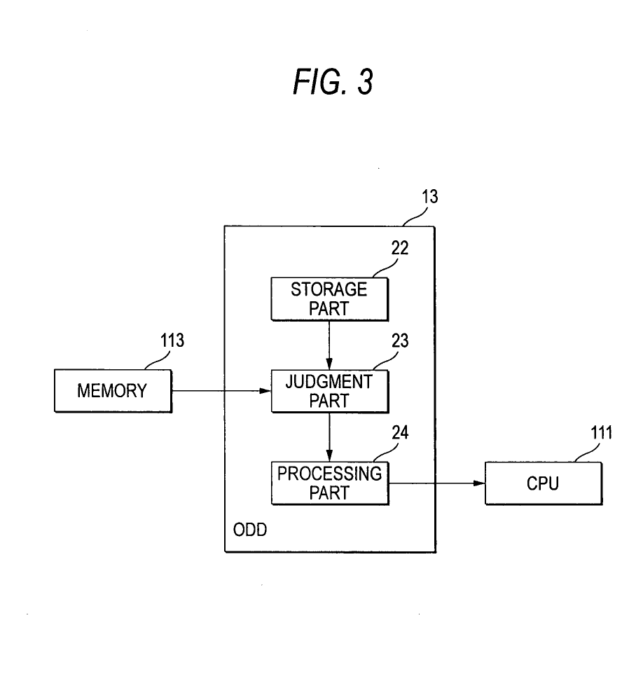

The ODD 13 includes a storage part (storage unit) 22, a judgment part (judging unit) 23 and a processing part 24, as shown in FIG. 3.

The storage part 22 is composed of a non-volatile memory, and has a function of storing designated optical disk information indicating the designated optical disk 21. The stored designated optical disk information is outputted to the judgment part 23.

The judgment part 23 has a function of judging whether or not the loaded optical disk 20 is the designated optical disk 21 based on the designated optical disk information outputted from the storage part 22. Also, if one or more kinds of designated optical disk 21 are designated, the judgment part has a function of judging preferentially the designated optical disk having higher frequency of use by referring to use history information stored in the main memory 113.

The processing part 24 has a function of performing at least one of the read process and the write process for the designated optical disk 21.

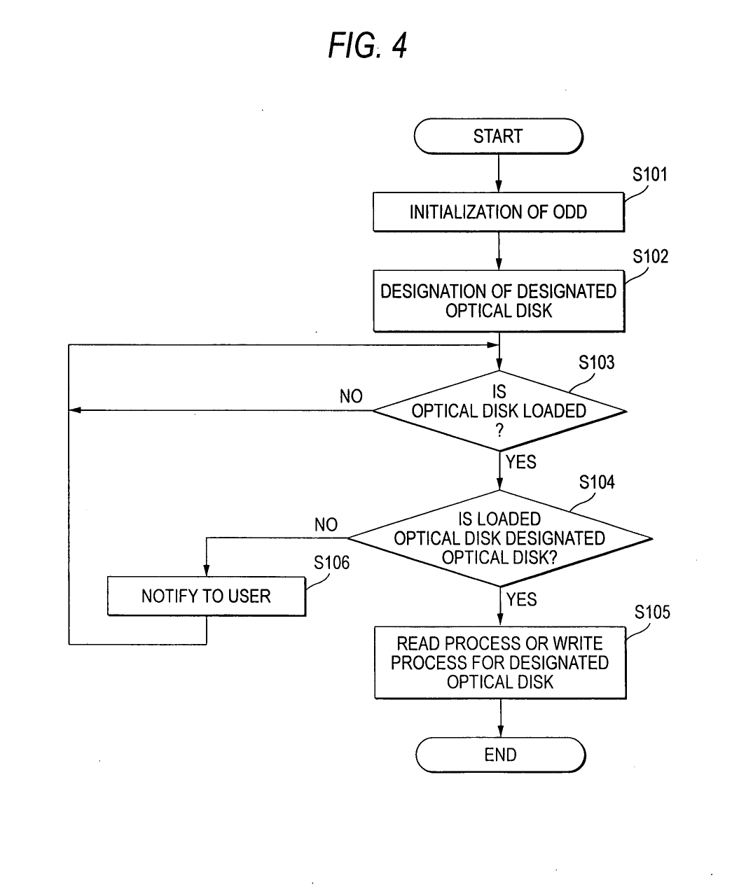

Referring to a flowchart of FIG. 4, a procedure for the read process or write process for the designated optical disk 21 that is performed by the personal computer 10 will be described below.

First of all, if the power of the personal computer 10 is turned ON, the ODD 13 is initialized (step S101).

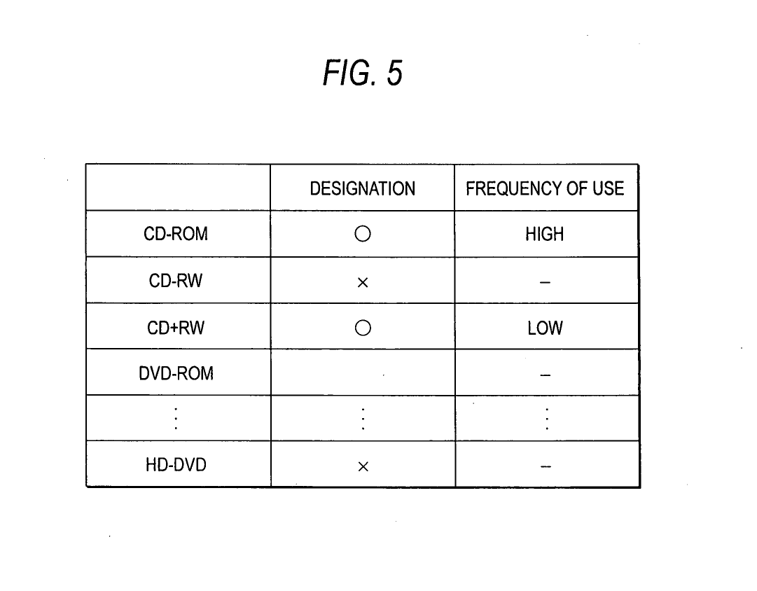

If the designated optical disk information of the designated optical disk 21 is stored in the storage part 22 by the user as shown in FIG. 5, CD-ROM and CD+RW are designated as the designated optical disk for the judgment part 23 (step S102).

And it is judged whether or not any optical disk 20 is loaded into the ODD 13 (step S103).

As a result of judgment at step S103, if the optical disk 20 is not loaded, the judgment whether or not any optical disk is loaded is continued (step S103).

As a result of judgment at step S103, if any optical disk 20 is loaded, the judgment part 23 of the ODD 13 judges whether or not the loaded optical disk 20 is CD-ROM. Also, if it is judged that the loaded optical disk is not CD-ROM, it is judged whether or not the loaded optical disk is CD+RW (step S104). Which of CD-ROM and CD+RW is preferentially judged is decided by referring to use history information stored in the main memory 113 and comparing the frequency of use between CD-ROM and CD+RW. Herein, CD-ROM having higher frequency of use is judged preferentially.

As a result of judgment at step S104, if the loaded optical disk 20 is CD-ROM or CD+RW, the processing part 24 enables the read process or write process to be performed for the designated optical disk 21. And the read process or write process is performed by the CPU 111 (step S105).

As a result of judgment at step S104, if the loaded optical disk 20 is neither CD-ROM nor CD+RW, a message “The loaded optical disk 20 is not designated optical disk 21” is displayed on the LCD 17 and notified to the user without making judgment for other optical disks 20 (step S106). At the same time, a notice “Is designated optical disk newly designated?” may be made to the user. Thereafter, the operation returns to the judgment whether or not any optical disk 20 is set (step S103).

If the user newly designates the designated optical disk 21 by accepting the notice, the new designated optical disk information is stored in the storage part 22, and at step S104, it is also judged whether or not the loaded optical disk 20 is the designated optical disk 21 newly designated.

As described above, in the personal computer 10, the designated optical disk 21 to be processed is designated by the input from the keyboard 14, and the ODD 13 enables at least one of the read process and the write process to be performed for only the designated optical disk 21. Thereby, the time required for identifying the kind of loaded optical disk 20 is shortened, so that the personal computer 10 can be booted up in a short time.

Also, in the personal computer 10, the judgment part 23 of the ODD 13 judges whether or not the loaded optical disk 20 is the designated optical disk 21. If it is judged that the loaded optical disk 20 does not correspond to any designated optical disk 21, a message that the loaded optical disk 20 does not correspond to any designated optical disk 21 is displayed on the LCD 17 and notified to the user without making judgment for other optical disks 20. Thereby, the user can newly designate the designated optical disk 21.

Also, in the personal computer 10, the ODD 13 is provided with the storage part 22 for storing the designated optical disk information indicating the designated optical disk 21, and the judgment part 23 judged whether or not the loaded optical disk 20 is the designated optical disk based on the designated optical disk information. Thereby, the designated optical disk information designated by the user can be stored in the storage part 22, and the designated optical disk can be added or changed at any time during operation of the personal computer 10.

Also, in the personal computer 10, when the judgment part 23 of the ODD 13 judges the designated optical disk, the designated optical disk 21 having higher frequency of use is preferentially processed by referring to use history information stored in the main memory 113. Thereby, even when one or more kinds of designated optical disk 21 are designated, the time required for identifying the optical disk 20 is shortened, so that the personal computer 10 can be booted up in a short time.

The invention is not limited to the above embodiment.

For example, the designated optical disk 21 is designated based on the designated optical disk information stored in the storage part 22 of the ODD 13 in the above embodiment, but instead, the designated optical disk 21 may be designated by a designation from the system BIOS after initialization without providing the storage part 22 in the ODD 13.

Also, a message that the loaded optical disk 20 is not designated optical disk 21 is displayed on the LCD 17 and notified to the user, but instead, it may be notified by issuing a sound from the speaker 19.

Also, the information processing apparatus is the personal computer, but instead, may be an HDD recorder or a car navigation system.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
an optical disk drive that performs at least one of a read process and a write process for a plurality of kinds of optical disk; and
a designation unit that designates at least one kind of an optical disk as a designated optical disk for which the at least one of the read process and the write process is performed,
wherein the optical disk drive performs the at least one of the read process and the write process only for the designated optical disk.

2. The information processing apparatus according to claim 1,
wherein the optical disk drive comprises a judging unit that judges whether or not an optical disk loaded to the optical disk drive is the designated optical disk, and
wherein the optical disk drive performs the at least one of the read process and the write process for the loaded optical disk if the judging unit judges that the loaded optical disk is the designated optical disk.

3. The information processing apparatus according to claim 2, further comprising a notify unit that indicates that the loaded optical disk is not the designated optical disk if the optical disk drive judges that the loaded optical disk is not the designated optical disk.

4. The information processing apparatus according to claim 1,
wherein the optical disk drive comprises a storage unit that stores a designated optical disk information indicating the designated optical disk, and
wherein the optical disk drive performs the at least one of the read process and the write process for the designated optical disk based on the designated optical disk information.

5. The information processing apparatus according to claim 1, wherein the optical disk drive comprises:
a storage unit that stores a designated optical disk information indicating the designated optical disk; and
a judging unit that judges whether or not an optical disk loaded to the optical disk drive is the designated optical disk by referring to the designated optical disk information, and
wherein the optical disk drive performs the at least one of the read process and the write process for the loaded optical disk if the judging unit judges that the loaded optical disk is the designated optical disk.

6. The information processing apparatus according to claim 5,
wherein the storage unit further stores use history information indicating frequency of use of the designated optical disk, and
wherein, if at least two kinds of the optical disk are designated as the designated optical disk, the judging unit refers to the use history information and judges whether or not the loaded optical disk is the designated optical disk in order of the frequency of use of the at least two kinds of the optical disk.

7. The information processing apparatus according to claim 1,
wherein, if at least two kinds of the optical disk are designated as the designated optical disk, the optical disk drive performs preferentially the at least one of the read process and the write process for the designated optical disk having higher frequency of use based on use history information indicating frequency of use of the optical disk.

8. An information processing method comprising:
designating at least one kind of an optical disk as a designated optical disk to which at least one of a read process and a write process is performed;
judging whether or not a loaded optical disk is the designated optical disk; and
performing the at least one of the read process and the write process for the loaded optical disk only if the loaded optical disk is judged to be the designated optical disk.

9. The information processing method according to claim 8,
wherein, if at least two kinds of the optical disk are designated as the designated optical disk, the judging comprises judging whether or not the loaded optical disk is the designated optical disk in order of a frequency of use of the at least two kinds of the optical disk.

10. The information processing method according to claim 9, further comprising:
indicating that the loaded optical disk is not the designated optical disk if the loaded optical disk is judged not to be the designated optical disk.
